(19) United States
(12) Patent Application Publication
(10) Pub. No.: US 2023/0041703 A1
(43) Pub. Date: Feb. 9, 2023

(54) SYSTEMS AND METHODS FOR FACILITATING GENERATION OF REAL ESTATE DESCRIPTIONS FOR REAL ESTATE ASSETS

(71) Applicants: Sunder Jagannathan, Coimbatore (IN); Vivek Agarwal, Faridabad (IN); Hitesh Singla, Gurgaon (IN)

(72) Inventors: Sunder Jagannathan, Coimbatore (IN); Vivek Agarwal, Faridabad (IN); Hitesh Singla, Gurgaon (IN)

(73) Assignee: SY Interiors Pvt. Ltd, New Delhi (IN)

(21) Appl. No.: 17/396,676

(22) Filed: Aug. 7, 2021

(51) Int. Cl. G06Q 50/16; G06F 16/2457; G06F 16/953

(52) U.S. Cl. CPC G06Q 50/16; G06F 16/24578; G06F 16/953

(57) ABSTRACT

Disclosed herein is a method for facilitating generation of real estate descriptions for real estate assets, in accordance with some embodiments. The method may include a step of receiving, using a communication device, real estate information of a real estate asset from a user device, a step of analyzing, using a processing device, the real estate information, a step of generating, using the processing device, a real estate description for the real estate asset using a machine learning model based on the analyzing, a step of receiving, using the communication device, a keyword relevant in a real estate industry from the user device, a step of generating, using the processing device, an optimized real estate description for the real estate asset based on the keyword and the real estate description, and storing, using a storage device, the optimized real estate description.

### TECHNICAL FIELD

Generally, the present disclosure relates to the field of data processing. More specifically, the present disclosure relates to methods, systems, apparatuses, and devices for facilitating generation of real estate descriptions for real estate assets.

### BACKGROUND

Generating descriptions for real estate requires human creativity. With the wide variety of properties available, it is difficult to craft fitting content that aptly describes a real estate listing. With thousands of brokers listing their properties, it is tough to compose or manually review the content uploaded by the user.

Existing techniques for facilitating generation of real estate descriptions for real estate assets are deficient with regard to several aspects. For instance, current technologies do not provide descriptions of the real estate assets that are search engine optimized. Furthermore, current technologies do not generate unique descriptions for real estate assets. Moreover, current technologies do not creatively generate descriptions for real estate assets.

Therefore, there is a need for methods, systems, apparatuses, and devices for facilitating generation of real estate descriptions for real estate assets that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating generation of real estate descriptions for real estate assets, in accordance with some embodiments. The method may include a step of receiving, using a communication device, at least one real estate information of at least one real estate asset from at least one user device. Further, the method may include a step of analyzing, using a processing device, the at least one real estate information. Further, the method may include a step of generating, using the processing device, at least one real estate description for the at least one real estate asset using at least one machine learning model based on the analyzing. Further, the method may include a step of receiving, using the communication device, at least one keyword relevant in a real estate industry from the at least one user device. Further, the method may include a step of generating, using the processing device, at least one optimized real estate description for the at least one real estate asset based on the at least one keyword and the at least one real estate description. Further, the method may include a step of storing, using a storage device, the at least one optimized real estate description.

Further disclosed herein is a method for facilitating generation of real estate descriptions for real estate assets, in accordance with some embodiments. The method may include a step of receiving, using a communication device, at least one real estate information of at least one real estate asset from at least one user device. Further, the method may include a step of receiving, using the communication device, at least one keyword relevant in a real estate industry from the at least one user device. Further, the method may include a step of analyzing, using a processing device, the at least one real estate information and the at least one keyword. Further, the method may include a step of generating, using the processing device, at least one optimized real estate description with respect to at least one search engine for the at least one real estate asset using at least one machine learning model based on the analyzing. Further, the method may include a step of storing, using a storage device, the at least one optimized real estate description.

Further disclosed herein is a system of facilitating generation of real estate descriptions for real estate assets, in accordance with some embodiments. The system may include a communication device, a processing device, and a storage device. Further, the communication device may be configured for performing a step of receiving at least one real estate information of at least one real estate asset from at least one user device. Further, the communication device may be configured for performing a step of receiving at least one keyword relevant in a real estate industry from the at least one user device. Further, the processing device may be communicatively coupled with the communication device. Further, the processing device may be configured for performing a step of analyzing the at least one real estate information. Further, the processing device may be configured for performing a step of generating at least one real estate description for the at least one real estate asset using at least one machine learning model based on the analyzing. Further, the processing device may be configured for performing a step of generating at least one optimized real estate description for the at least one real estate asset based on the at least one keyword and the at least one real estate description. Further, the storage device may be communicatively coupled with the processing device. Further, the storage device may be configured for performing a step of storing the at least one optimized real estate description.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating generation of real estate descriptions for real estate assets, in accordance with some embodiments.

FIG. 4 is a flow chart of a method for facilitating generation of real estate descriptions for real estate assets, in accordance with some embodiments.

FIG. 5 is a continuation flow chart of FIG. 4.

FIG. 6 is a flow chart of a method for facilitating generation of real estate descriptions for real estate assets, in accordance with some embodiments.

FIG. 7 is a continuation flow chart of FIG. 6.

FIG. 8 is a flow chart of a method for facilitating generation of real estate descriptions for real estate assets, in accordance with some embodiments.

FIG. 9 is a flow chart of a method for facilitating generation of real estate descriptions for real estate assets, in accordance with some embodiments.

FIG. 10 is a flow chart of a method for facilitating generation of real estate descriptions for real estate assets, in accordance with some embodiments.

FIG. 11 is a block diagram of a system for facilitating generation of real estate descriptions for real estate assets, in accordance with some embodiments.

FIG. 12 is a schematic diagram of an area map of an area associated with a real estate asset, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating generation of real estate descriptions for real estate assets, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Definitions

The real estate descriptions may include marketable content on features and properties of the real estate assets.

The real estate assets may include a property. The property may be comprised of a land and a structure built on the land. The real estate asset may include a plot of land, a building, an apartment, etc.

The at least one real estate information may include one or more parameters or one or more characteristics of the at least one real estate asset. The one or more parameters may include a location, a builder, an area, a floor size, etc.

The at least one real estate description may include marketable content on features and properties of the at least one real estate asset.

The at least one real estate description may include at least one paragraph of the content that includes at least one key information associated with the at least one real estate asset in a well-stitched and smooth flowing manner.

The at least one machine learning model generates a textual description of the at least one real estate asset using the one or more parameters or the one or more characteristic of the at least one real estate asset. The at least one real estate description comprises the textual description.

The at least one optimized real estate asset may include the marketable content comprising the at least one keyword. Further, a ranking of the at least one optimized real estate description is higher than the ranking of the at least one real estate description with respect to a search engine.

The at least one search engine may include a Google™ search engine, a Yahoo™ search engine, a Bing™ search engine, etc.

The at least one search engine information may include one or more rules for ranking the content.

The one or more completion words may be used for forming unique and meaningful sentences and phrases with the one or more parameters.

The at least one completion word may include at least one semantic completion word.

The selecting of the at least one completion word further provides a semantic completion to the at least one real estate description.

The at least one keyword content may include descriptions, definitions, contexts, usages, synonyms, etc. of the at least one keyword.

The auto-regressive language model may include a GPT3 model.

The real estate descriptions may include marketable content on features and properties of the real estate assets.

The real estate assets may include a property. The property may be comprised of a land and a structure built on the land. The real estate asset may include a plot of land, a building, an apartment, etc.

Overview

The present disclosure describes methods, systems, apparatuses, and devices for facilitating generation of real estate descriptions for real estate assets.

Further, the present disclosure describes an automatic real estate description generator. Further, the real estate description generator generates the real estate description based on inputs from basic fields for taking SEO advantage. Further, the automatic real estate description generator is configured for:

1. Creating short description from 20+ parameters like location, builder, area info, floor size 2. Getting SEO advantage for unique description that's created

Further, the present disclosure describes AI-based Real Estate Content Generation.

Further, the present disclosure describes a Real Estate content generation tool that generates highly marketable SEO-friendly unique content for properties. The model takes a few key parameters of the property as its input and then as output it generates a few paragraphs of content that contains all the key information provided in a well-stitched and smooth flowing manner. This AI-generated content as compared to human-generated content has resulted in much better results in terms of higher lift rate and click-through rates for those listings.

With the human creative talent being really costly and highly non-scaleable, we started analyzing a lot of real estate listings and the content. After analyzing about 5+ million listings and their content, we zeroed in a few key listing details that any user looks for while shortlisting a property. We were primarily catering to different sets of customers and based on these the content varied greatly.

1. Properties for Sale

2. Properties for Rent

The general pointers that played a key role in the user making a decision about the property were as follows:
Area
Locality
City
Age of Property
Price of property

We weaved this key information from multiple listings and then trained a GPT3 model. We experimented with multiple variations and settings of the GPT3 model and finally settled down with the following setting.

Model Settings for Uniqueness: With the huge volume of the listings (10,000+) that flow into the listing platform daily, crafting unique content was next to impossible even for highly creative individuals who are plagued with cognitive biases. Each content will be customized and even when the tool is run for the same set of parameters, the model comes up with totally different and unique content. This has been achieved by using the higher value of temperature parameter which allows the models to come up with more creative content as the sampling is done from the completion words. Every content will be customized, and changes based on your parameters and settings provided. The text generated will also be SEO-friendly; each paragraph is generated in a way that will enhance search engine rankings by inserting keywords that we found were most relevant in the real estate industry. The model is a powerful content-generating tool that cuts weeks from content that was earlier composed by humans. All the content that is created is unique, SEO-friendly, and grammatically correct while being tailored to the needs and tastes of the real estate users.

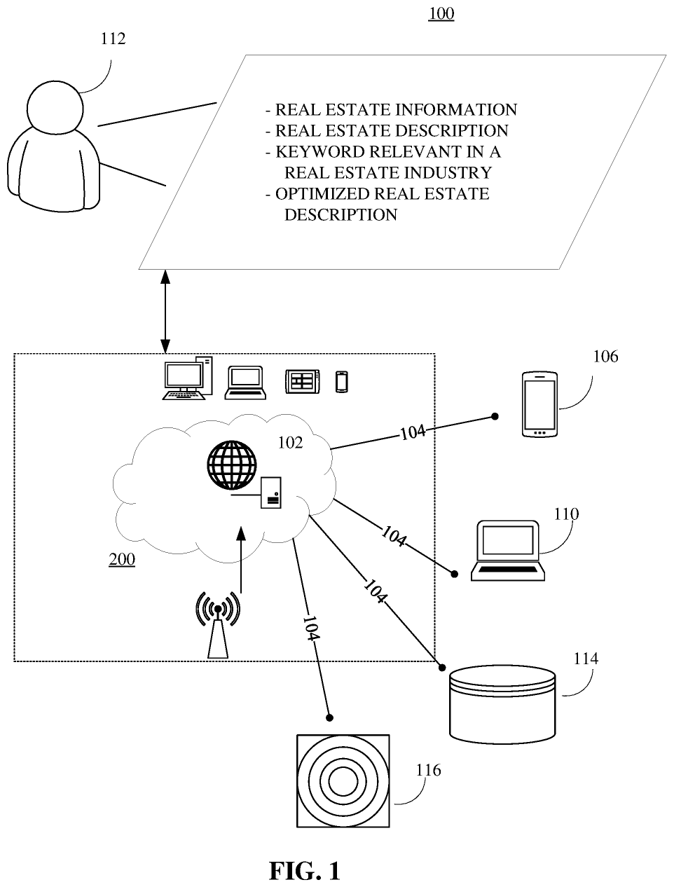

Referring now to figures, FIG. 1 is an illustration of an online platform 100 consistent with various embodiments of the present disclosure. By way of non-limiting example, the online platform 100 to enable facilitating generation of real estate descriptions for real estate assets may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

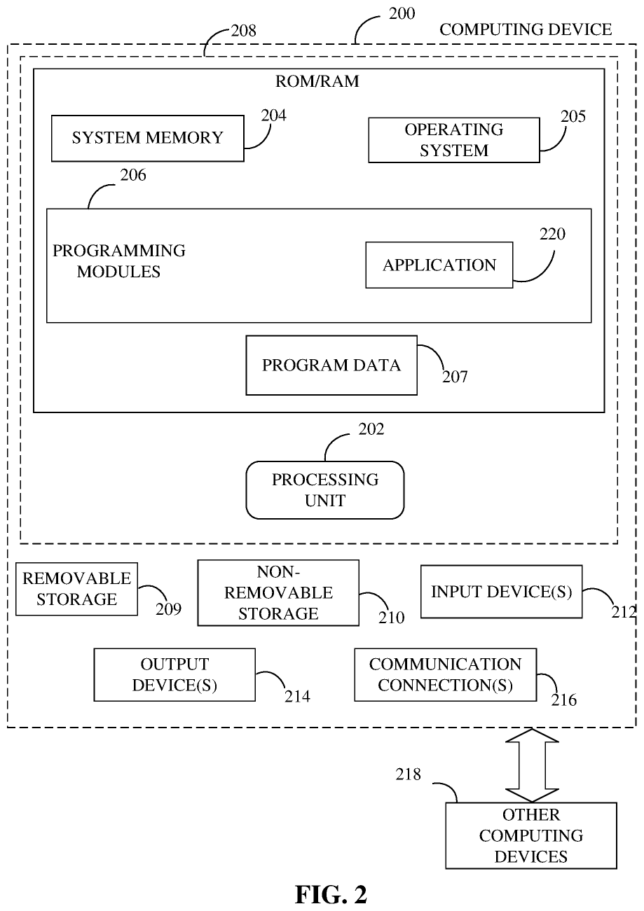

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

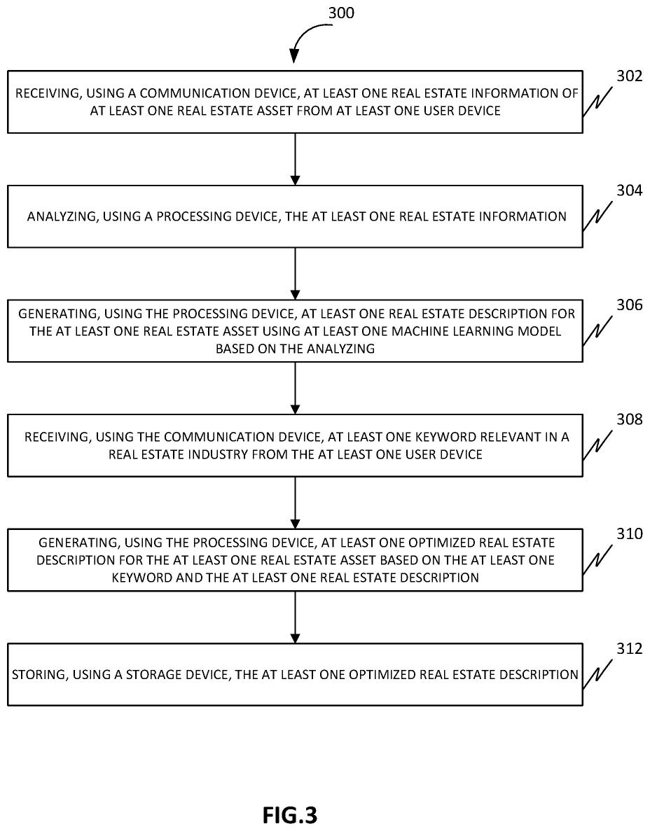

FIG. 3 is a flow chart of a method 300 for facilitating generation of real estate descriptions for real estate assets, in accordance with some embodiments.

Further, at 302, the method 300 may include receiving, using a communication device, at least one real estate information of at least one real estate asset from at least one user device.

Further, at 304, the method 300 may include analyzing, using a processing device, the at least one real estate information.

Further, at 306, the method 300 may include generating, using the processing device, at least one real estate description for the at least one real estate asset using at least one machine learning model based on the analyzing.

Further, at 308, the method 300 may include receiving, using the communication device, at least one keyword relevant in a real estate industry from the at least one user device.

Further, at 310, the method 300 may include generating, using the processing device, at least one optimized real estate description for the at least one real estate asset based on the at least one keyword and the at least one real estate description.

Further, at 312, the method 300 may include storing, using a storage device, the at least one optimized real estate description.

In some embodiments, the storing of the at least one optimized real estate description may include storing the at least one optimized real estate description in a distributed ledger.

In some embodiments, the at least one real estate information may include one or more location information, builder information, size information, asset price information, amenities information, and asset age information of the at least one real estate asset.

In some embodiments, the at least one machine model may include at least one natural language generation model. Further, the at least one real estate description may include at least one natural language real estate description. Further, the generating of the at least one real estate description may include generating the at least one natural language real estate description using the at least one natural language generation model.

In some embodiments, the at least one machine learning model may be an autoregressive language model.

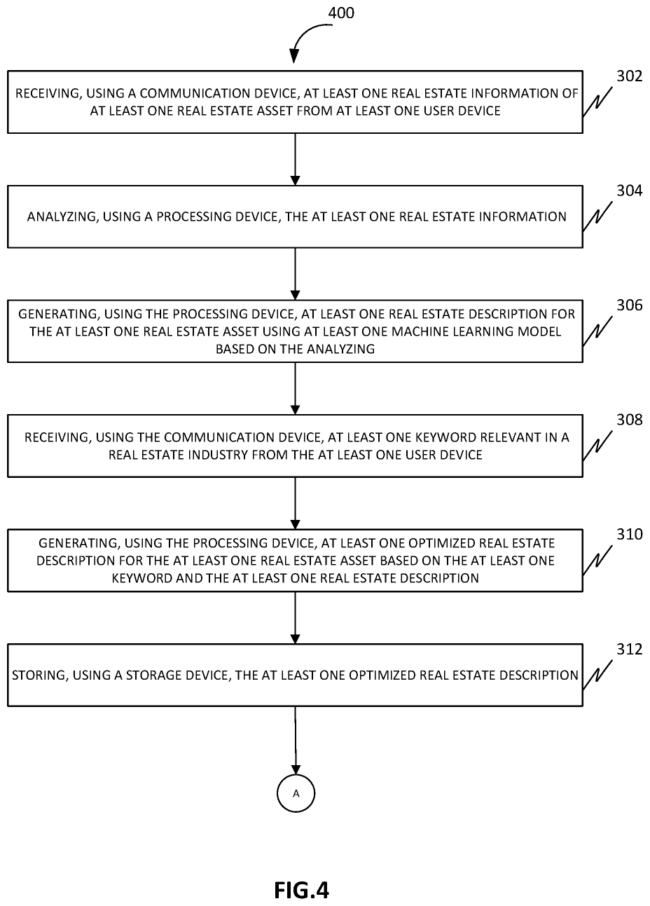

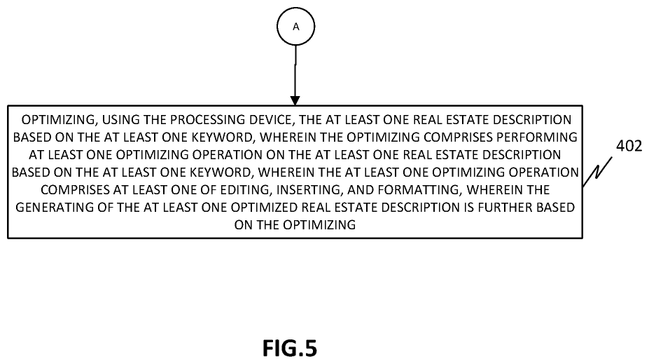

FIG. 4 is a flow chart of a method 400 for facilitating generation of real estate descriptions for real estate assets, in accordance with further embodiments. FIG. 5 is a continuation flow chart of FIG. 4. Further, at 402, the method 400 may include optimizing, using the processing device, the at least one real estate description based on the at least one keyword. Further, the optimizing comprises performing at least one optimizing operation on the at least one real estate description based on the at least one keyword. Further, the at least one optimizing operation comprises at least one of editing, inserting, and formatting. Further, the generating of the at least one optimized real estate description is based on the optimizing.

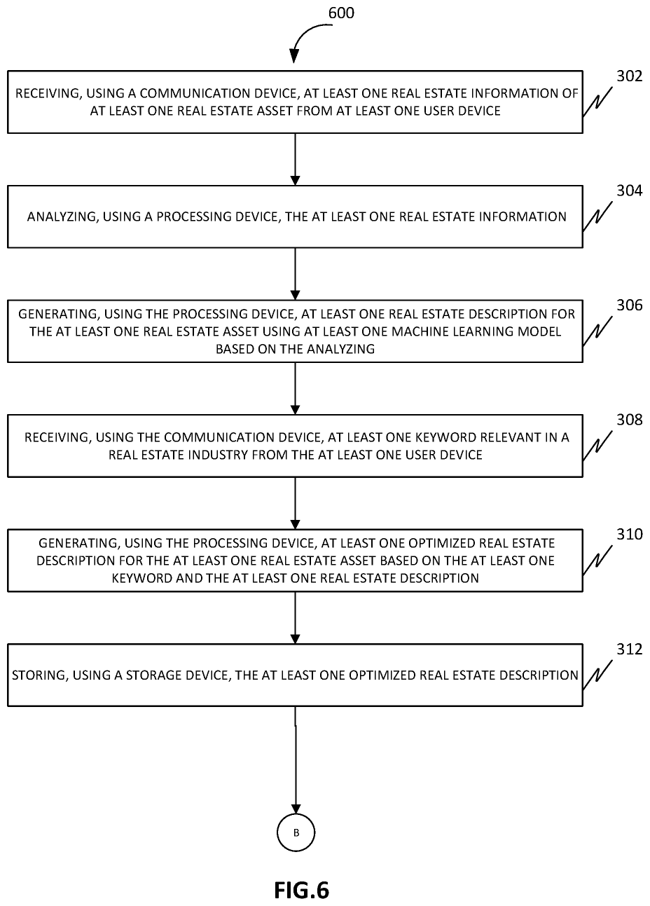

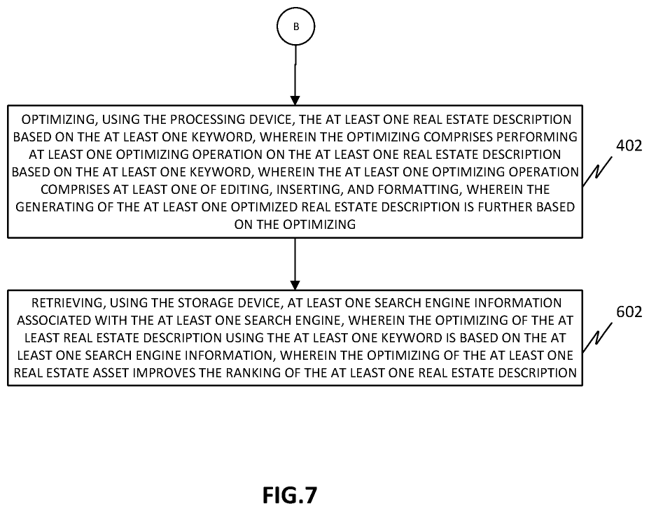

FIG. 6 is a flow chart of a method 600 for facilitating generation of real estate descriptions for real estate assets, in accordance with further embodiments. FIG. 7 is a continuation flow chart of FIG. 6. Further, the at least one real estate description may be associated with a ranking with respect to at least one search engine. Further, at 602, the method 600 may include retrieving, using the storage device, at least one search engine information associated with the at least one search engine. Further, the optimizing of the at least real estate description using the at least one keyword is based on the at least one search engine information. Further, the optimizing of the at least one real estate asset improves the ranking of the at least one real estate description.

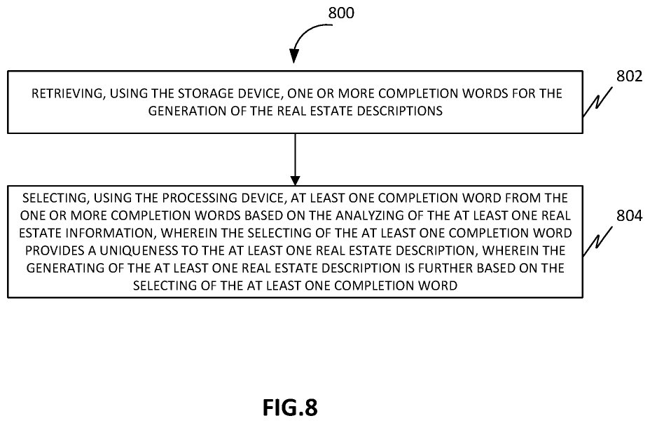

FIG. 8 is a flow chart of a method 800 for facilitating generation of real estate descriptions for real estate assets, in accordance with some embodiments. Further, at 802, the method 800 may include retrieving, using the storage device, one or more completion words for the generation of the real estate descriptions. Further, at 804, the method 800 may include selecting, using the processing device, at least one completion word from the one or more completion words based on the analyzing of the at least one real estate information. Further, the selecting of the at least one completion word provides a uniqueness to the at least one real estate description. Further, the generating of the at least one real estate description is based on the selecting of the at least one completion word.

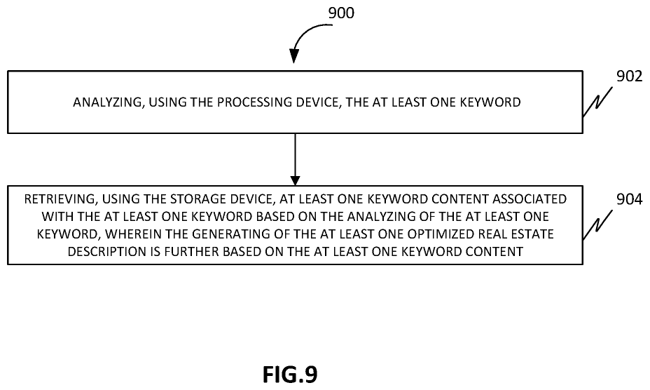

FIG. 9 is a flow chart of a method 900 for facilitating generation of real estate descriptions for real estate assets, in accordance with some embodiments. Further, at 902, the method 900 may include analyzing, using the processing device, the at least one keyword. Further, at 904, the method 900 may include retrieving, using the storage device, at least one keyword content associated with the at least one keyword based on the analyzing of the at least one keyword. Further, the generating of the at least one optimized real estate description is based on the at least one keyword content.

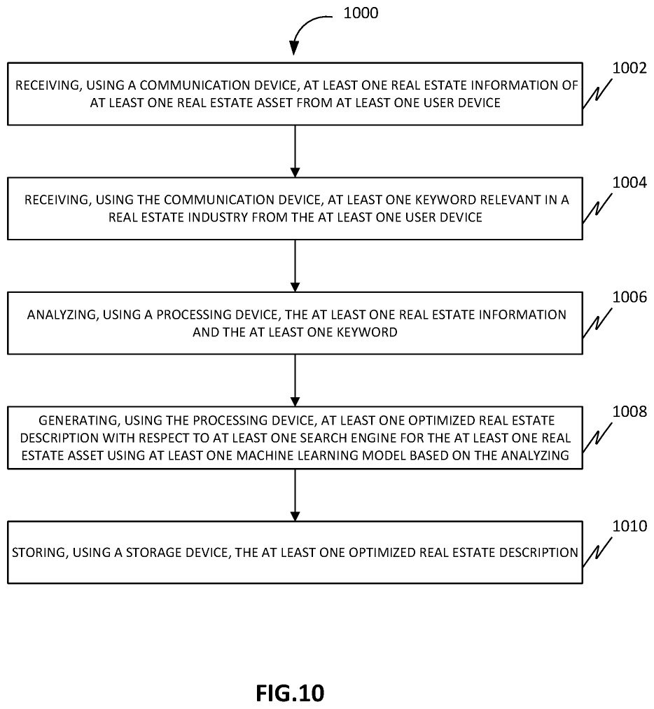

FIG. 10 is a flow chart of a method 1000 for facilitating generation of real estate descriptions for real estate assets, in accordance with some embodiments.

Further, at 1002, the method 1000 may include receiving, using a communication device, at least one real estate information of at least one real estate asset from at least one user device.

Further, at 1004, the method 1000 may include receiving, using the communication device, at least one keyword relevant in a real estate industry from the at least one user device.

Further, at 1006, the method 1000 may include analyzing, using a processing device, the at least one real estate information and the at least one keyword.

Further, at 1008, the method 1000 may include generating, using the processing device, at least one optimized real estate description with respect to at least one search engine for the at least one real estate asset using at least one machine learning model based on the analyzing.

Further, at 1010, the method 1000 may include storing, using a storage device, the at least one optimized real estate description.

In some embodiments, the storing of the at least one optimized real estate description may include storing the at least one optimized real estate description in a distributed ledger.

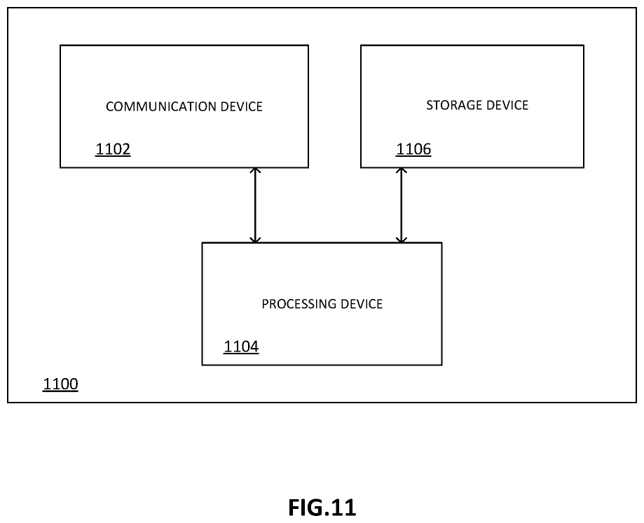

FIG. 11 is a block diagram of a system 1100 for facilitating generation of real estate descriptions for real estate assets, in accordance with some embodiments. The system 1100 may include a communication device 1102, a processing device 1104, and a storage device 1106.

Further, the communication device 1102 may be configured for performing a step of receiving at least one real estate information of at least one real estate asset from at least one user device.

Further, the communication device 1102 may be configured for performing a step of receiving at least one keyword relevant in a real estate industry from the at least one user device.

Further, the processing device 1104 may be communicatively coupled with the communication device 1102.

Further, the processing device 1104 may be configured for performing a step of analyzing the at least one real estate information.

Further, the processing device 1104 may be configured for performing a step of generating at least one real estate description for the at least one real estate asset using at least one machine learning model based on the analyzing.

Further, the processing device 1104 may be configured for performing a step of generating at least one optimized real estate description for the at least one real estate asset based on the at least one keyword and the at least one real estate description.

Further, the storage device 1106 may be communicatively coupled with the processing device 1104.

Further, the storage device 1106 may be configured for performing a step of storing the at least one optimized real estate description.

In some embodiments, the storing of the at least one optimized real estate description may include storing the at least one optimized real estate description in a distributed ledger.

In some embodiments, the at least one real estate information may include one or more of location information, builder information, size information, asset price information, amenities information, and asset age information of the at least one real estate asset.

In some embodiments, the at least one machine model may include at least one natural language generation model. Further, the at least one real estate description may include at least one natural language real estate description. Further, the generating of the at least one real estate description may include generating the at least one natural language real estate description using the at least one natural language generation model.

In some embodiments, the at least one machine learning model may be an autoregressive language model.

In some embodiments, the processing device 1104 may be configured for performing a step of optimizing the at least one real estate description based on the at least one keyword. Further, the optimizing may include performing at least one optimizing operation on the at least one real estate description based on the at least one keyword. Further, the at least one optimizing operation may include one or more of editing, inserting, and formatting. Further, the generating of the at least one optimized real estate description may be based on the optimizing.

In some embodiments, the at least one real estate description may be associated with a ranking with respect to at least one search engine. Further, the storage device 1106 may be configured for performing a step of retrieving at least one search engine information associated with the at least one search engine. Further, the optimizing of the at least real estate description using the at least one keyword may be based on the at least one search engine information. Further, the optimizing of the at least one real estate asset improves the ranking of the at least one real estate description.

In some embodiments, the storage device 1106 may be configured for performing a step of retrieving one or more completion words for the generation of the real estate descriptions. Further, the processing device 1104 may be configured for performing a step of selecting at least one completion word from the one or more completion words based on the analyzing of the at least one real estate information. Further, the selecting of the at least one completion word provides a uniqueness to the at least one real estate description. Further, the generating of the at least one real estate description may be based on the selecting of the at least one completion word.

In some embodiments, the processing device 1104 may be configured for performing a step of analyzing the at least one keyword. Further, the storage device 1106 may be configured for performing a step of retrieving at least one keyword content associated with the at least one keyword based on the analyzing of the at least one keyword. Further, the generating of the at least one optimized real estate description may be based on the at least one keyword content.

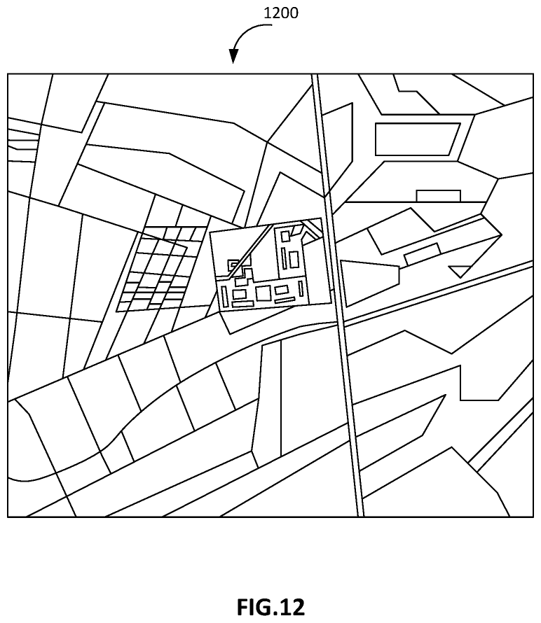

FIG. 12 is a schematic diagram of an area map 1200 of an area associated with a real estate asset, in accordance with some embodiments. Further, the area map 1200 may include legal information associated with the real estate asset, civic infrastructure information of civic infrastructures present in the area, future planned development information of future planned developments in the area, price information associated with prices of the real estate, construction information associated with constructions in the real estate asset, project history information associated with a project history of the real estate asset, builder profile information associated with a builder profile of a builder associated with the real estate asset, and watch outs information associated with watch outs of the area. Further, the legal information may include a land acquisition status, license chronology, environment clearances, etc. Further, the civic infrastructures information roads and connectivity, sewage and pipelines, electricity and utilities, etc. Further, the future planned development information may include master plan information, metro and other connectivity, business hubs, malls and shopping, etc. Further, the price information may include real time market price, builder prices, special schemes, etc. Further, the construction information may include tower wise construction status, place of construction, quality of construction, etc. Further, the project history information may include launch data, major events and price triggers, major flags +ve and −ve, etc. Further, the builder profile information past projects delivery, in pipeline projects, creditworthiness and financial strength, etc. Further, the watch outs information may include adjoining villages, slum, drains, STPs, under construction zones, etc.

Although the present disclosure has been explained in relation to its preferred embodiment, it is to be understood that many other possible modifications and variations can be made without departing from the spirit and scope of the disclosure.

We claim:

1. A method for facilitating generation of real estate descriptions for real estate assets, the method comprising:
receiving, using a communication device, at least one real estate information of at least one real estate asset from at least one user device;
analyzing, using a processing device, the at least one real estate information;
generating, using the processing device, at least one real estate description for the at least one real estate asset using at least one machine learning model based on the analyzing;
receiving, using the communication device, at least one keyword relevant in a real estate industry from the at least one user device;
generating, using the processing device, at least one optimized real estate description for the at least one real estate asset based on the at least one keyword and the at least one real estate description; and
storing, using a storage device, the at least one optimized real estate description.

2. The method of claim 1 further comprising optimizing, using the processing device, the at least one real estate description based on the at least one keyword, wherein the optimizing comprises performing at least one optimizing operation on the at least one real estate description based on the at least one keyword, wherein the at least one optimizing operation comprises at least one of editing, inserting, and formatting, wherein the generating of the at least one optimized real estate description is further based on the optimizing.

3. The method of claim 2, wherein the at least one real estate description is associated with a ranking with respect to at least one search engine, wherein the method further comprises retrieving, using the storage device, at least one search engine information associated with the at least one search engine, wherein the optimizing of the at least real estate description using the at least one keyword is based on the at least one search engine information, wherein the optimizing of the at least one real estate asset improves the ranking of the at least one real estate description.

4. The method of claim 1 further comprising:
retrieving, using the storage device, one or more completion words for the generation of the real estate descriptions; and
selecting, using the processing device, at least one completion word from the one or more completion words based on the analyzing of the at least one real estate information, wherein the selecting of the at least one completion word provides a uniqueness to the at least one real estate description, wherein the generating of the at least one real estate description is further based on the selecting of the at least one completion word.

5. The method of claim 1, wherein the storing of the at least one optimized real estate description comprises storing the at least one optimized real estate description in a distributed ledger.

6. The method of claim 1, wherein the at least one real estate information comprises at least one of location information, builder information, size information, asset price information, amenities information, and asset age information of the at least one real estate asset.

7. The method of claim 1, wherein the at least one machine model comprises at least one natural language generation model, wherein the at least one real estate description comprises at least one natural language real estate description, wherein the generating of the at least one real estate description comprises generating the at least one natural language real estate description using the at least one natural language generation model.

8. The method of claim 1 further comprising:
analyzing, using the processing device, the at least one keyword; and
retrieving, using the storage device, at least one keyword content associated with the at least one keyword based on the analyzing of the at least one keyword, wherein the generating of the at least one optimized real estate description is further based on the at least one keyword content.

9. The method of claim 1, wherein the at least one machine learning model is an autoregressive language model.

10. A method for facilitating generation of real estate descriptions for real estate assets, the method comprising:
receiving, using a communication device, at least one real estate information of at least one real estate asset from at least one user device;
receiving, using the communication device, at least one keyword relevant in a real estate industry from the at least one user device;
analyzing, using a processing device, the at least one real estate information and the at least one keyword;
generating, using the processing device, at least one optimized real estate description with respect to at least one search engine for the at least one real estate asset using at least one machine learning model based on the analyzing; and
storing, using a storage device, the at least one optimized real estate description.

11. The method of claim 10, wherein the storing of the at least one optimized real estate description comprises storing the at least one optimized real estate description in a distributed ledger.

12. A system for facilitating generation of real estate descriptions for real estate assets, the system comprising:
a communication device configured for:
receiving at least one real estate information of at least one real estate asset from at least one user device; and
receiving at least one keyword relevant in a real estate industry from the at least one user device;
a processing device communicatively coupled with the communication device, wherein the processing device is configured for:
analyzing the at least one real estate information;
generating at least one real estate description for the at least one real estate asset using at least one machine learning model based on the analyzing; and
generating at least one optimized real estate description for the at least one real estate asset based on the at least one keyword and the at least one real estate description; and
a storage device communicatively coupled with the processing device, wherein the storage device is configured for storing the at least one optimized real estate description.

13. The system of claim 12, wherein the processing device is further configured for optimizing the at least one real estate description based on the at least one keyword, wherein the optimizing comprises performing at least one optimizing operation on the at least one real estate description based on the at least one keyword, wherein the at least one optimizing operation comprises at least one of editing, inserting, and formatting, wherein the generating of the at least one optimized real estate description is further based on the optimizing.

14. The system of claim 13, wherein the at least one real estate description is associated with a ranking with respect to at least one search engine, wherein the storage device is further configured for retrieving at least one search engine information associated with the at least one search engine, wherein the optimizing of the at least real estate description using the at least one keyword is based on the at least one search engine information, wherein the optimizing of the at least one real estate asset improves the ranking of the at least one real estate description.

15. The system of claim 12, wherein the storage device is further configured for retrieving one or more completion words for the generation of the real estate descriptions, wherein the processing device is further configured for selecting at least one completion word from the one or more completion words based on the analyzing of the at least one real estate information, wherein the selecting of the at least one completion word provides a uniqueness to the at least one real estate description, wherein the generating of the at least one real estate description is further based on the selecting of the at least one completion word.

16. The system of claim 12, wherein the storing of the at least one optimized real estate description comprises storing the at least one optimized real estate description in a distributed ledger.

17. The system of claim 12, wherein the at least one real estate information comprises at least one of location information, builder information, size information, asset price information, amenities information, and asset age information of the at least one real estate asset.

18. The system of claim 12, wherein the at least one machine model comprises at least one natural language generation model, wherein the at least one real estate description comprises at least one natural language real estate description, wherein the generating of the at least one real estate description comprises generating the at least one natural language real estate description using the at least one natural language generation model.

19. The system of claim 12, wherein the processing device is further configured for analyzing the at least one keyword, wherein the storage device is further configured for retrieving at least one keyword content associated with the at least one keyword based on the analyzing of the at least one keyword, wherein the generating of the at least one optimized real estate description is further based on the at least one keyword content.

20. The system of claim 12, wherein the at least one machine learning model is an autoregressive language model.
